(19) United States
(12) Patent Application Publication
(10) Pub. No.: US 2024/0141729 A1
(43) Pub. Date: May 2, 2024

(54) LIFTING AND LOWERING HANDRAIL STRUCTURE FOR LADDER

(71) Applicant: New-Tec Integration (Xiamen) Co., Ltd., Xiamen City (CN)

(72) Inventor: Luhao LENG, Xiamen City (CN)

(21) Appl. No.: 18/346,354

(22) Filed: Jul. 3, 2023

(30) Foreign Application Priority Data
Nov. 2, 2022 (CN) 202222947589.9

(51) Int. Cl. E06C 7/18

(52) U.S. Cl. CPC E06C 7/182

(57) ABSTRACT

A lifting and lowering handrail structure for a ladder comprises a handrail frame. A side of a lower end of at least one of two side rods comprises a locking hole, the lower end is sleeved with a handheld sleeve, and a button is pivotally connected to the handheld sleeve. The button comprises a protrusion pin configured to correspond to the locking hole, and the protrusion pin is configured to be disposed in the locking hole due to driving of an elastic member. Two leg pipes comprise at least one position-limiting hole configured to correspond to the locking hole, and the protrusion pin is configured to pass through the locking hole to be disposed in the at least one position-limiting hole when the two side rods are telescopically sleeved with the two leg pipes to enable the locking hole to be aligned with the at least one position-limiting hole.

### RELATED APPLICATIONS

This application claims priority to Chinese patent application number 202222947589.9, filed on Nov. 2, 2022. Chinese patent application number 202222947589.9 is incorporated herein by reference.

### FIELD OF THE DISCLOSURE

The present disclosure relates to a lifting and lowering handrail structure for a ladder, and in particular to a lifting and lowering handrail structure for a foldable aluminum ladder.

### BACKGROUND OF THE DISCLOSURE

The existing foldable aluminum ladder has advantages of lightness and convenient storage, and the existing foldable aluminum ladder is a commonly used tool for families and is sold in large supermarkets. Existing foldable aluminum ladders can be roughly divided into two categories based upon handrails: one is V-shaped ladders without handrails, and the other is splay-shaped ladders with handrails. The handrails can play a protective role, and at the same time, it is convenient for a user to stand on an uppermost step platform more stably. Most of the existing handrails are directly fixed to leg pipes of the ladder. The ladder has an integral structure having the handrails, the handrails are welded to the ladder, or the handrails and the ladder are bolt-locked to each other. That is, the handrails are fixed to the ladder. Considering the problem of storage, the handrails have a lower height, so safety protection that the handrails can bring during use still needs to be improved.

### BRIEF SUMMARY OF THE DISCLOSURE

The present disclosure provides a lifting and lowering handrail structure for a ladder, which has a function of adjusting a handrail to telescope and overcomes the shortcomings of the background. A technical solution of the present disclosure is as follows.

A lifting and lowering handrail structure for a ladder comprises a handrail frame. The handrail frame comprises an upper lateral rod and two side rods symmetrically arranged in a left-and-right direction. An upper end of each of the two side rods is connected to an end of the upper lateral rod, and the two side rods are configured to be telescopically sleeved with two leg pipes of the ladder. A side of a lower end of at least one of the two side rods comprises a locking hole, and the lower end of the at least one of the two side rods is sleeved with a handheld sleeve. A button is pivotally connected to the handheld sleeve, and the button comprises a protrusion pin configured to correspond to the locking hole. The protrusion pin is configured to be disposed in the locking hole due to driving of an elastic member, and the two leg pipes comprise at least one position-limiting hole configured to correspond to the locking hole. The protrusion pin is configured to pass through the locking hole to be disposed in the at least one position-limiting hole when the two side rods are telescopically sleeved with the two leg pipes to enable the locking hole to be aligned with the at least one position-limiting hole.

When in use, the protrusion pin is inserted into the locking hole and the at least one position-limiting hole at the same time due to a force applied by the elastic member, so as to inhibit relative movement of the two side rods and the two leg pipes to achieve a function of fixing the handrail frame. When a height of the handrail frame needs to be adjusted, the button is pressed to move the protrusion pin out to enable the handrail frame to be adjusted. Thereby, the lifting and lowering handrail structure has an advantage of being convenient to adjust the height of the handrail frame. The handrail frame can be lowered rapidly when being stored, and the height of the handrail frame can be adjusted according to requirements of the user, so that safety of the ladder when in use can be ensured.

In a preferred embodiment, the handheld sleeve has a C-shaped cross-section and comprises a first opening located on an inner side of the ladder, and each of the two side rods has a C-shaped cross-section and comprises a second opening located on the inner side. The C-shaped cross-section has a better effect of providing space, and avoiding the handrail frame and a hinge structure in the two leg pipes interfering with each other during a lowering and lifting process of the handrail frame.

In a preferred embodiment, a middle part of the button is pivotally connected to the handheld sleeve, the protrusion pin is located inside of a lower end of the button, the elastic member is located inside of an upper end of the button, and the handheld sleeve comprises a through hole corresponding to the protrusion pin. Thereby, a pressing control to the button can be performed by a more flexible finger, which is more convenient.

In a preferred embodiment, the handheld sleeve comprises a position-providing hole. A first end of the elastic member passes through the position-providing hole to abut a corresponding one of the two side rods, and a positioning member located inside of the button is disposed in a second end of the elastic member. Thereby, two ends of the elastic member can be positioned, which has a more firm structure.

In a preferred embodiment, the button is located on a rear side of the corresponding one of the two side rods. Thereby, the handheld sleeve can be held to enable the user to press the button, and the handrail frame can be held by holding the handheld sleeve to move up and down, which is convenient.

In a preferred embodiment, the handheld sleeve is buckled to a corresponding one of the two side rods.

In a preferred embodiment, an outwardly protruding buckle is formed on the corresponding one of the two side rods by stamping, the handheld sleeve comprises a buckle hole, and the outwardly protruding buckle is buckled to the buckle hole.

In a preferred embodiment, a lower end of the corresponding one of the two side rods is disposed in the handheld sleeve.

In a preferred embodiment, the at least one position-limiting hole is formed on the two leg pipes by stamping, and a deformed portion of the two leg pipes corresponding to the at least one position-limiting hole is stamped to form a tongue plate extending horizontally inward. The tongue plate can guide movement of the protrusion pin.

In a preferred embodiment, the upper end of each of the two side rods is spliced with the upper lateral rod through a connecting member.

In a preferred embodiment, each of the two side rods is disposed with one of the handheld sleeves.

### BRIEF DESCRIPTION OF THE DRAWINGS

The present disclosure will be further described below in combination with the accompanying drawings and embodiments.

FIG. 1 illustrates a perspective view of a ladder.

FIG. 2 illustrates another perspective view of the ladder shown in FIG. 1.

FIG. 3 illustrates an exploded view of the ladder shown in FIG. 1.

FIG. 4 illustrates an exploded view of a handrail frame, a handheld sleeve, a button, and an elastic member of the ladder shown in FIG. 1.

FIG. 5 illustrates a cross-sectional view of the ladder shown in FIG. 1 along a line A-A.

FIG. 6 illustrates an enlarged view of a circled part in FIG. 5.

FIG. 7 illustrates a perspective view of the ladder shown in FIG. 1 after the handrail frame is lowered.

### DETAILED DESCRIPTION OF THE EMBODIMENTS

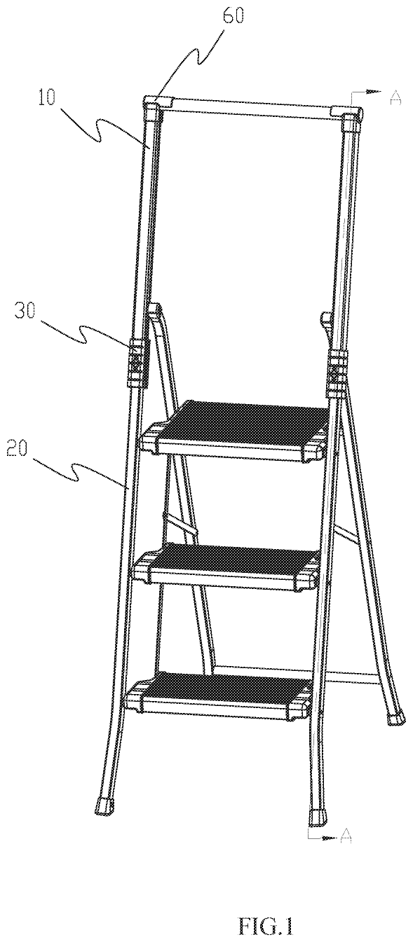

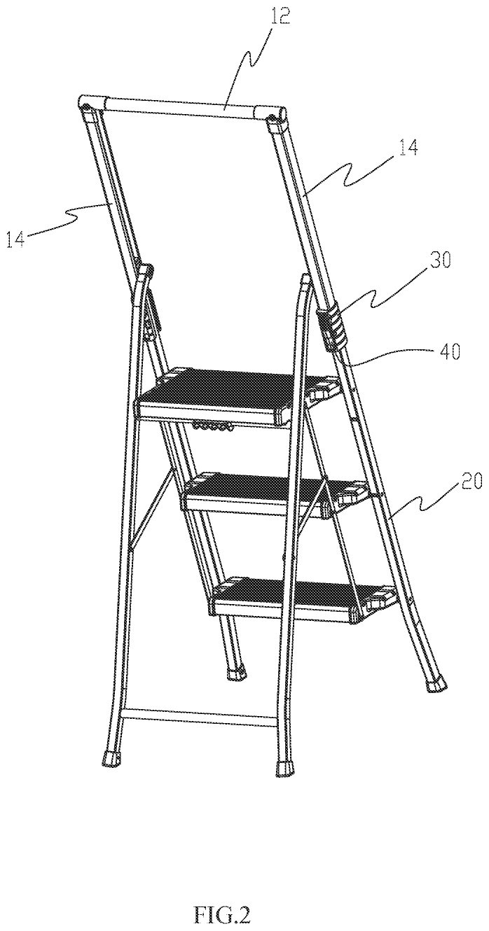

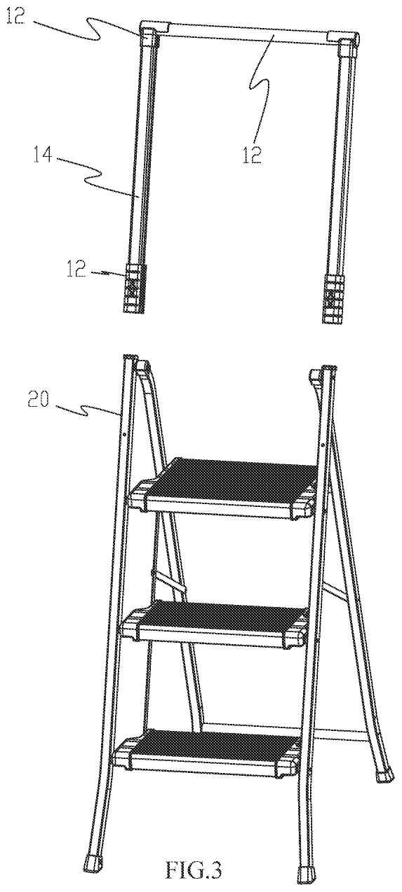

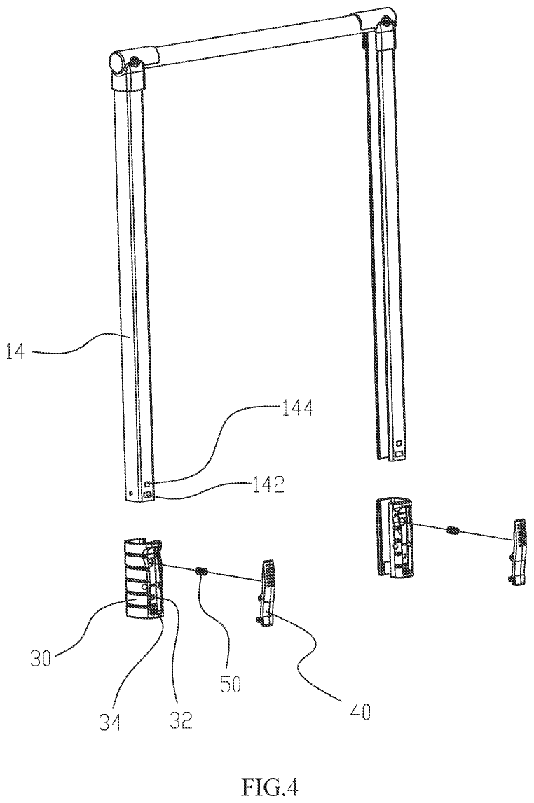

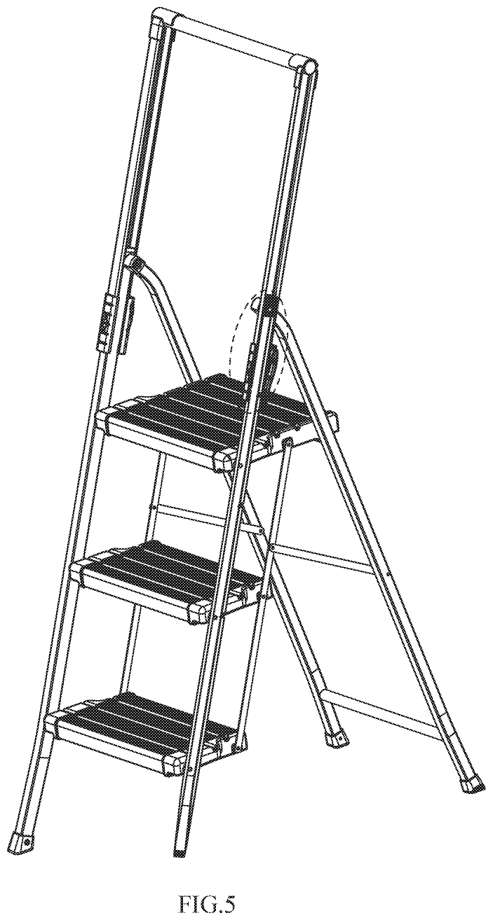

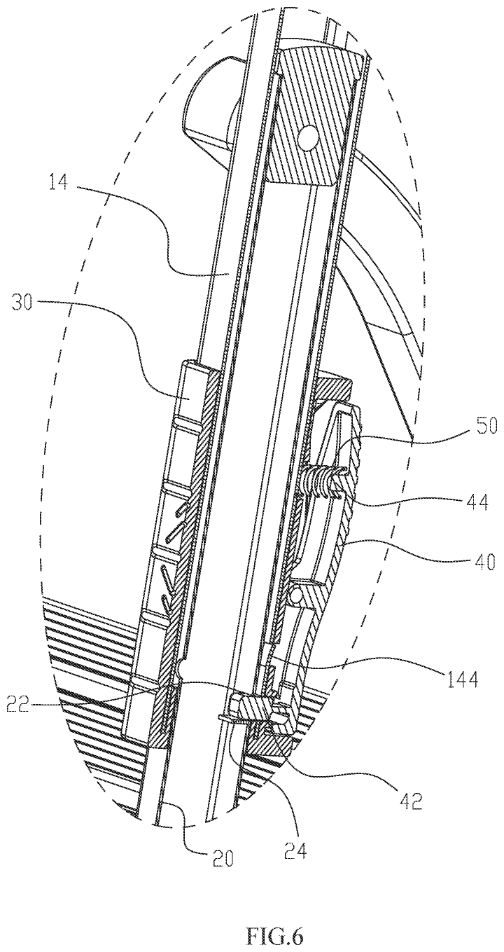

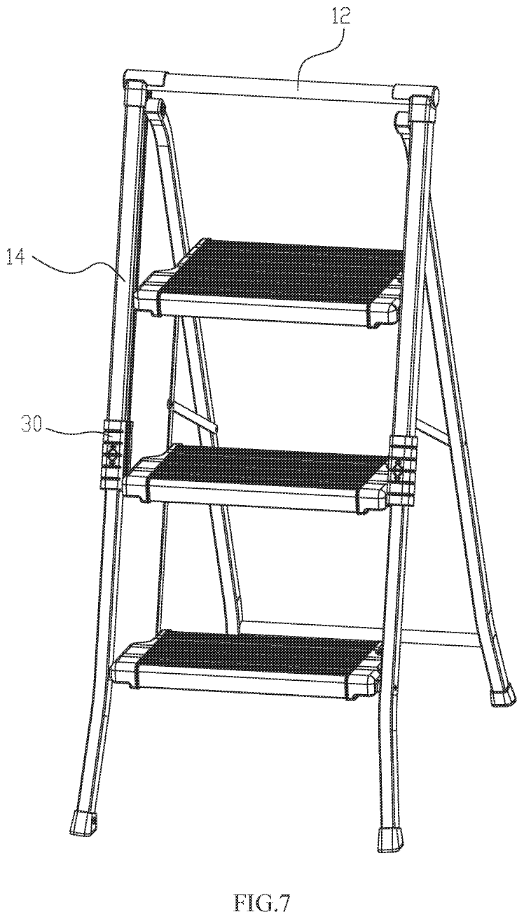

Referring to FIG. 1 and FIG. 7, a lifting and lowering handrail structure in the present is provided for being used in a ladder, and a height of a handrail frame can be adjusted by using the lifting and lowering handrail structure, which will be described in detail below in conjunction with accompanying FIGS. 1-7.

The lifting and lowering handrail structure comprises a handrail frame 10, and the handrail frame 10 comprises an upper lateral rod 12 and two side rods 14 symmetrically arranged in a left-and-right direction. An upper end of each of the two side rods 14 is connected to an end of the upper lateral rod 12. The two side rods 14 are configured to be telescopically sleeved with two leg pipes 20 of the ladder. A side of a lower end of at least one of the two side rods 14 comprises a locking hole 142, and the lower end of the at least one of the two side rods 14 is sleeved with a handheld sleeve 30. A button 40 is pivotally connected to the handheld sleeve 30, and the button 40 comprises a protrusion pin 42 configured to correspond to the locking hole 142. The protrusion pin 42 is configured to be inserted into the locking hole 142 due to driving of an elastic member 50. The two leg pipes 20 comprise at least one position-limiting hole 22 configured to correspond to the locking hole 142, and the protrusion pin 42 can pass through the locking hole 142 to be inserted into the at least one position-limiting hole 22 when the two side rods 14 are telescopically sleeved with the two leg pipes 20 to enable the locking hole 142 to be aligned with the at least one position-limiting hole 22.

Preferably, the handheld sleeve 30 has a C-shaped cross-section and comprises an opening located on an inner side. Each of the two side rods 14 has a C-shaped cross-section and comprises an opening located on the inner side. The inner sides are sides of the two side rods 14 opposite to each other, that is, towards an inside of the ladder.

Preferably, a middle part of the button 40 is pivotally connected to the handheld sleeve 30. The protrusion pin 42 is located inside of a lower end of the button 40, and the elastic member 50 is located inside of an upper end of the button 40. The handheld sleeve 30 comprises a through hole 34 corresponding to the protrusion pin 42. That is, due to a force applied by the elastic member 50, the protrusion pin 42 passes through the through hole 34 and is inserted into the locking hole 142 and the at least one position-limiting hole 22.

Preferably, the handheld sleeve 30 comprises a position-providing hole. A first end of the elastic member 50 passes through the position-providing hole to abut a corresponding one of the two side rods 14, and a positioning member 44 located inside of the button 40 is inserted into a second end of the elastic member 50. In this embodiment, the positioning member 44 is a protruding structure, and the elastic member 50 is a spring.

Preferably, the button 40 is located on a rear side of the corresponding one of the two side rods 14. The rear side is a side facing away from a user.

Preferably, the handheld sleeve 30 is buckled to the corresponding one of the two side rods 14. More preferably, an outwardly protruding buckle 144 is formed on the corresponding one of the two side rods 14 by stamping, and the handheld sleeve 30 comprises a buckle hole 32. The outwardly protruding buckle 144 is buckled to the buckle hole 32. In addition, in this embodiment, a lower end of the corresponding one of the two side rods 14 is inserted into the handheld sleeve 30.

Preferably, the at least one position-limiting hole 22 is formed on the two leg pipes 20 by stamping, and a deformed portion of the two leg pipes 20 corresponding to the at least one position-limiting hole 22 is stamped to form a tongue plate 24 extending horizontally inward.

Preferably, the upper end of each of the two side rods 14 is spliced with the upper lateral rod 12 through a connecting member 60.

Preferably, each of the two side rods 14 is disposed with one of the handheld sleeves 30.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A lifting and lowering handrail structure for a ladder, comprising:
a handrail frame, wherein:
the handrail frame comprises an upper lateral rod and two side rods symmetrically arranged in a left-and-right direction,
an upper end of each of the two side rods is connected to an end of the upper lateral rod,
the two side rods are configured to be telescopically sleeved with two leg pipes of the ladder,
a side of a lower end of at least one of the two side rods comprises a locking hole,
the lower end of the at least one of the two side rods is sleeved with a handheld sleeve,
a button is pivotally connected to the handheld sleeve,
the button comprises a protrusion pin configured to correspond to the locking hole,
the protrusion pin is configured to be disposed in the locking hole due to driving of an elastic member,
the two leg pipes comprise at least one position-limiting hole configured to correspond to the locking hole, and
the protrusion pin is configured to pass through the locking hole to be disposed in the at least one position-limiting hole when the two side rods are telescopically sleeved with the two leg pipes to enable the locking hole to be aligned with the at least one position-limiting hole.

2. The lifting and lowering handrail structure for a ladder according to claim 1, wherein:
the handheld sleeve has a C-shaped cross-section and comprises a first opening located on an inner side of the ladder, and
each of the two side rods has a C-shaped cross-section and comprises a second opening located on the inner side.

3. The lifting and lowering handrail structure for a ladder according to claim 1, wherein:
a middle part of the button is pivotally connected to the handheld sleeve,
the protrusion pin is located inside of a lower end of the button,
the elastic member is located inside of an upper end of the button, and
the handheld sleeve comprises a through hole corresponding to the protrusion pin.

4. The lifting and lowering handrail structure for a ladder according to claim 3, wherein:
the handheld sleeve comprises a position-providing hole,
a first end of the elastic member passes through the position-providing hole to abut a corresponding one of the two side rods, and
a positioning member located inside of the button is disposed in a second end of the elastic member.

5. The lifting and lowering handrail structure for a ladder according to claim 4, wherein:
the button is located on a rear side of the corresponding one of the two side rods.

6. The lifting and lowering handrail structure for a ladder according to claim 1, wherein:
the handheld sleeve is buckled to a corresponding one of the two side rods.

7. The lifting and lowering handrail structure for a ladder according to claim 6, wherein:
an outwardly protruding buckle is formed on the corresponding one of the two side rods by stamping,
the handheld sleeve comprises a buckle hole,
the outwardly protruding buckle is buckled to the buckle hole, and
a lower end of the corresponding one of the two side rods is disposed in the handheld sleeve.

8. The lifting and lowering handrail structure for a ladder according to claim 1, wherein:
the at least one position-limiting hole is formed on the two leg pipes by stamping, and
a deformed portion of the two leg pipes corresponding to the at least one position-limiting hole is stamped to form a tongue plate extending horizontally inward.

9. The lifting and lowering handrail structure for a ladder according to claim 1, wherein:
the upper end of each of the two side rods is spliced with the upper lateral rod through a connecting member.

10. The lifting and lowering handrail structure for a ladder according to claim 1, wherein:
each of the two side rods is disposed with one of the handheld sleeves.

11. The lifting and lowering handrail structure for a ladder according to claim 2, wherein:
a middle part of the button is pivotally connected to the handheld sleeve,
the protrusion pin is located inside of a lower end of the button,
the elastic member is located inside of an upper end of the button, and
the handheld sleeve comprises a through hole corresponding to the protrusion pin.

12. The lifting and lowering handrail structure for a ladder according to claim 11, wherein:
the handheld sleeve comprises a position-providing hole,
a first end of the elastic member passes through the position-providing hole to abut a corresponding one of the two side rods, and
a positioning member located inside of the button is disposed in a second end of the elastic member.

13. The lifting and lowering handrail structure for a ladder according to claim 12, wherein:
the button is located on a rear side of the corresponding one of the two side rods.
